(19) United States
(12) Patent Application Publication
(10) Pub. No.: US 2023/0371749 A1
(43) Pub. Date: Nov. 23, 2023

(54) Combination Condiment Shaker

(71) Applicant: Jun Lu, Sugar Land, TX (US)

(72) Inventor: Jun Lu, Sugar Land, TX (US)

(21) Appl. No.: 18/108,007

(22) Filed: Feb. 9, 2023

Related U.S. Application Data
(60) Provisional application No. 63/308,269, filed on Feb. 9, 2022.

(51) Int. Cl. A47J 42/34

(52) U.S. Cl. CPC A47J 42/34

(57) ABSTRACT

The present invention comprises a condiment shaker/crusher for crushing, holding and dispensing seasonings to add taste to edible food. The condiment shaker comprises a body member having an opening. The body member is made of a squeezable material and defines an interior space for holding the seasonings to be crushed and dispensed. A top is removably engaged about the opening of the body member.

### BACKGROUND OF THE INVENTION

This invention relates to condiment dispensers. More specifically this invention relates to a condiment shaker the incorporates the design of a condiment crusher.

Condiment dispensers are used in the Western culture to allow diners to distribute edible grains that are used to add seasoning onto foods. Ground salt and pepper shakers are well known within society. Normally the design of condiment shakers of each condiment shaker displayed is the same. Additionally, with some condiment designs a grinder is provider to crush peppercorns.

The present invention provides a novel design of a unique condiment dispenser/crusher which provides seasonings upon food during dining.

### SUMMARY OF THE INVENTION

One objective of the present invention is to provide a cost-effective and durable design for the condiment crusher/shaker.

Another object of the present invention is to provide a condiment shaker that is aesthetical pleasing appearance.

Another objective of the present invention is to provide furniture that is selectively multi-functional configurable.

Additional objects, advantages, and other novel features of the present invention will be set forth in part in the description that follows and in part will become apparent to those skilled in the art upon examination of the following or may be learned with the practice of the invention. The objects and advantages of the invention may be realized and attained by means of the instrumentalities and combinations particularly pointed out in the appended claims.

To achieve the foregoing and other objects, and in accordance with the purposes of the present invention as described herein, improved condiment shakers are provided for holding, crushing and dispensing seasonings. The condiment shaker comprises a body member having a mouth. The body member is made of a squeezable material and defines an interior space for holding the seasonings to be crushed and dispensed. A top is removably engaged about the mouth of the body member. The seasonings to be crushed can be crackers, Cheetos, hot Cheetos, chips, tortilla chips, or any other crushable seasonings.

Still other objects of the present invention will become readily apparent to those skilled in this art from the following description wherein there is shown and described a preferred embodiment of this invention simply by way of illustration of one of the modes best suited to carry out the invention. As it will be realized, the invention is capable of other different embodiments and its several details are capable of modifications in various, obvious aspects, all without departing from the invention. Accordingly, the drawings and descriptions will be regarded as illustrative in nature and not as restrictive.

### BRIEF DESCRIPTION OF DRAWINGS

These and other details of the present invention will be described in connection with the accompanying drawings, which are not furnished only by way of illustration and not in limitation of the invention.

FIG. 1 is an exploded perspective view of present invention, a combination condiment shaker and crusher.

FIG. 2 is a perspective view of the present invention with the body member disposed within the hand of a user.

FIG. 3 is a perspective view of the present invention with the body member disposed in a downward position.

FIG. 4 is an alternative embodiment of the present invention with the body member having a square shape.

### DETAILED DESCRIPTION OF THE INVENTION

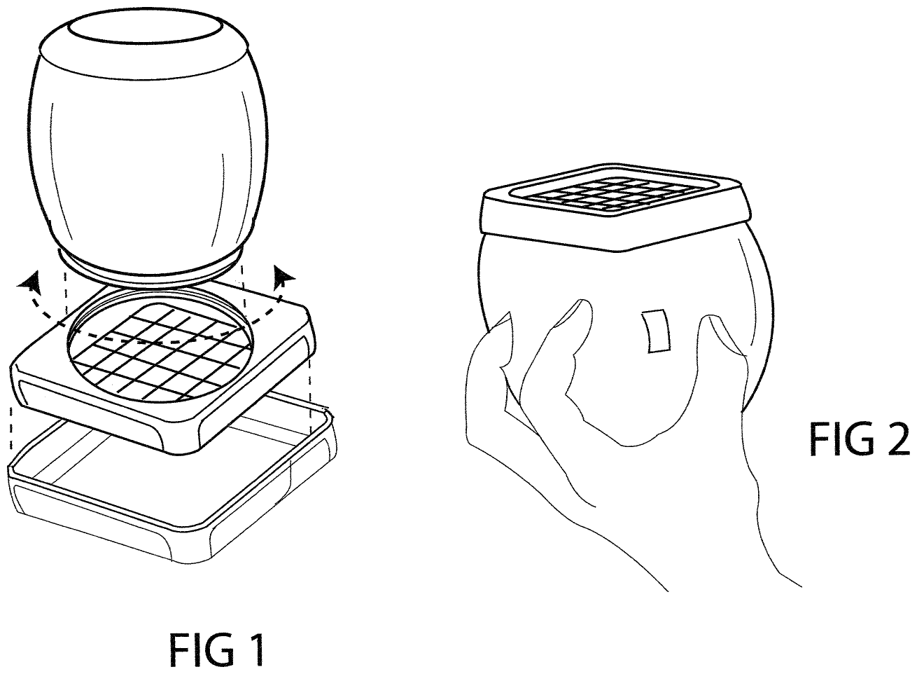

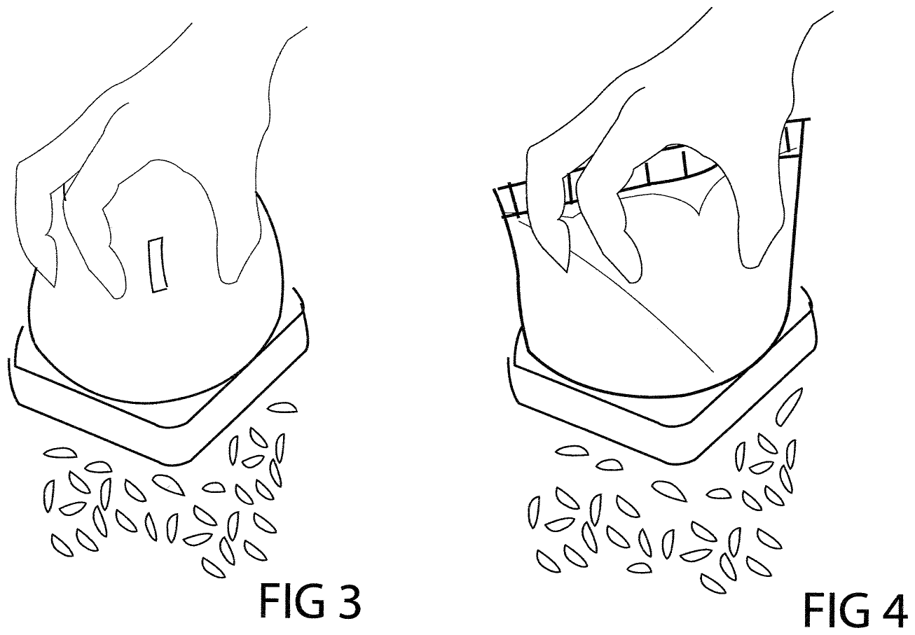

FIGS. 1-4 depicts an exampere embodiment of a new novel condiment container (10) according to the present invention. The condiment container (10) comprises a body member (15) defined by a closed bottom wall (12) with an opened top with a surrounding sidewall therebetween. The opened top is securely engaged with a lid (20) having a plurality of orifices for dispersing the condiment contained within the body member (15).

In the illustrated embodiment, body member (15) has a circular cross-section with the surrounding wall enclosing a hollow internal chamber that receives the condiment to be crushed. One skilled in the art should know that the body member (15) cross-section can be made of other shapes such as polygonal. The body member (15) is made of a flexible material that is squeezable. Silicone is one such material that can be used to make the body member. However, the body member can be made of outer suitable plastic or composite material that is squeezable. The outer surface of the opened top forms a rim which has outer threads for engagement. The rim has a smaller circumference in comparison to circumference of the body member.

The underside of the bottom wall forms a flat platform for allowing the container to sit on a flat surface. Additionally, the circumference of the bottom wall has a smaller circumference in comparison to the circumference of the body member.

In the illustrated embodiment, the lid (20) has a polygonal shape and is defined by a top side and an underside. The top side has an inner opening extending to the underside with a circumference substantially equivalent the rim (35) of the body member (15). The inner opening has threads for engaging with the rim of (35) the body member (15). In this illustrated embodiment the lid (20) has a rectangular shape. However, the lid (20) can have alternative shapes to support the shape of the body member (15).

The under side of the lid (20) further comprises a plurality of apertures to support the disbursement of the crushed condiment from the internal chamber of the body member (15).

Additionally, the lid (20) further comprises a cover (25) having substantially the same shape as the lid (20). The cover (25) comprises a closed bottom wall with a surrounding lip that extends upwardly to engage with the surrounding outer perimeter of the lid (20). As shown the surround outer perimeter of lid (20) has connecting members for engaging with corresponding inner attachments of the cover (25).

As shown in FIG. 4, body member (15) can be polygonal and made of an aluminum paper material. The condiment container (10) functions the same. Condiments are placed within the internal chamber of the body member (15) wherein the condiments can be crushed and dispersed through the underside of the lid (20). In the illustrated embodiment the opening of the body member (15) and the openings in the lid (20) are substantially larger than a smaller traditional container.

The food materials crushed within the condiment dispenser can be potato chips of any flavor, Cheetos of any flavoring, Doritos of any flavoring, tortilla chips of any flavoring, corn chips of any flavoring, crackers of any flavoring, and any other type of chip or crackers. The aforementioned crushed particles create different flavoring that can be dispersed on food to enhance flavoring.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A container for crushing condiments contained therein, the container comprising:
a body member having a bottom wall and an opened top with a surrounding sidewall therebetween wherein an internal chamber is formed therein;
the surrounding wall being made of a flexible material wherein condiments contained within the internal chamber can be crushed;
the opened top forms a rim for securely engaging with a lid; and
the lid having a plurality of spaced apart orifices for dispensing the condiments contained within the internal chamber.

2. The container of claim 1 wherein the circumference of the bottom wall has a smaller circumference relative to the circumference of the body member.

3. The container of claim 1 wherein the body member has a shape selected from the group consisting of polygonal, circular, oval, triangular, and elliptical.

4. The container of claim 1 wherein the body member is made of a material selected from the group consisting of silicone, cellophane, plastic, and aluminum paper.

5. The container of claim 1 further comprising a cover having a closed bottom wall with a surrounding lip that extends downwardly to securely engage with the outer surrounding perimeter of the lid.

6. A method for dispensing condiments contained within the container of claim 1.

7. The method of claim 6 further comprising:
a. placing condiments within the container through the opened top'
b. securing the lid with the opened top;
c. squeezing the surrounding wall of the body member; and
d. dispensing the condiments from the body member through the orifices of the lid.
